(19) United States
(12) Patent Application Publication
(10) Pub. No.: US 2008/0120248 A1
(43) Pub. Date: May 22, 2008

(54) Currency transaction process

(76) Inventor: Claus Peter Roehr, Palm Coast, FL (US)

Correspondence Address: William M. Hobby, III, 157 E. New England Avenue, #375, Winter Park, FL, 32789, US

(21) Appl. No.: 11/599,750

(22) Filed: Nov. 16, 2006

(51) Int. Cl. G06Q 40/00

(52) U.S. Cl. 705/36 R; 705/37

(57) ABSTRACT

The present invention relates to a process of executing an on-line transaction for the purchase and sale of currencies or other traded assets. A sale order is entered simultaneously with the purchase order to take effect upon the market price reaching either a predetermined gain or loss in value. Tokens of predetermined denominations are used to execute the transactions.

### BACKGROUND OF THE INVENTION

The present invention relates to a process of executing an on-line transaction for the purchase and sale of currencies or other traded assets. A sale order is entered simultaneously with the purchase order to take effect upon the market price reaching either a predetermined gain or loss in value. Tokens of predetermined denominations are used to execute the transactions.

It has become common practice to execute trading transactions in a variety of marketable assets on-line through computers connected to brokerage houses. This has become common practice in dealing in the purchase or sale of stocks and bonds as well as mutual funds, currency trading and in commodities. In each case, market data can be continuously followed for any particular stock or stock index as well as for any currency or commodity including trading in precious metals, such as gold, in which the price is constantly changing based on the market activity with the buying and selling of each asset over an exchange. The opening up of the internet has allowed individuals from anywhere in the world to follow the market activity for any particular asset as well for indexes and averages on a continuous basis and to execute trades through a broker from any remote location.

The present invention is directed towards performing trading of an asset and especially to the trading of currencies remotely from a remote trading station which can be a modified computer terminal with a display and which tokens are used to execute transactions and which places a buy and a sell order for the currency or other asset at the same time with the sale being executed only upon a predetermined changes in the market value of the currency.

In the past, it has been suggested to utilize an electronic stock market terminal game. As shown in the Chodak et al. U.S. Pat. No. 4,363,489, an electronic stock market game has a plurality of displays and input positions which players may trade in stock listed by the game, which display shows a player's price at which a stock is selling and gives general and specific information relating to the price of the stocks. The player selects a stock to trade in and keys in an order. A microprocessor executes the order and controls the display to indicate the status of all stocks in the player's account. The Lindsey et al. U.S. Pat. No. 5,285,383, is a method for carrying out transactions of goods using electronic titles has a commodity trading system having a centralized computer and database. Each commodity, such as a bale of cotton, is represented in the database so that the electronic representation of title eliminates the transfer of documentary type titles. The Mills et al. U.S. Pat. No. 7,024,386 relates to an electronic brokerage system in which counterparties trade anonymous within fixed credit limits. Such system trades financial instruments, such as foreign exchange and forward rate agreements. In the Kolls U.S. Pat. No. 6,629,080, a transaction processing method of handling an electronic commerce transaction with an electronic commerce terminal system. The system relates to a universal advertising and payment system and method for networking, monitoring and effectuating electronic commerce and controlling vending equipment. In the Hoffberg, U.S. Pat. No. 6,850,252, an intelligent electronic appliance includes a user interface, a data input and output port, and an intelligent processor. In the Hinkle, U.S. Pat. No. 6,442,533, a multi-processing financial transaction processing system provides processing efficiencies and a method of processing financial transactions.

### SUMMARY OF THE INVENTION

The process of executing a currency transaction, or the like, including the buying and selling of a currency which includes the steps of opening a trading account with a broker and receiving an account number. Tokens of predetermined currency denominations are then purchased for use in currency trading. A trading station is selected remote from the brokerage firm which trading station may have a housing and a display and has an on-line trading input of currency asset trading data displayable on the display. The trading may also have a token input and has an output to a transaction broker for handling trades including means for actuating the trade with the transaction broker. The person using the trading station enters the trader account number and selects a type of trading transaction including upper and lower selling price for the transaction. Purchased tokens are then input into the trading station and the trade is executed to buy currency or to buy another tradeable asset through the transaction broker for the amount of the token. The trading station actuates a sale through the transaction broker responsive to a predetermined targeted change in market price for the purchased asset whereby an asset buy/sale transaction is initiated from a remote trading station. The buy transaction automatically includes a sell order at a predetermined rise or fall of the market price of the purchased asset.

### BRIEF DESCRIPTION OF THE DRAWINGS

Other objects, features, and advantages of the present invention will be apparent from the written description and the drawings in which:

FIG. 1 is a block diagram of an opening of the brokerage account;

FIG. 2 is a diagrammatic view of a trading station in accordance with the present invention; and

FIG. 3 is a block diagram of the process in accordance with the present invention.

### DESCRIPTION OF THE PREFERRED EMBODIMENT

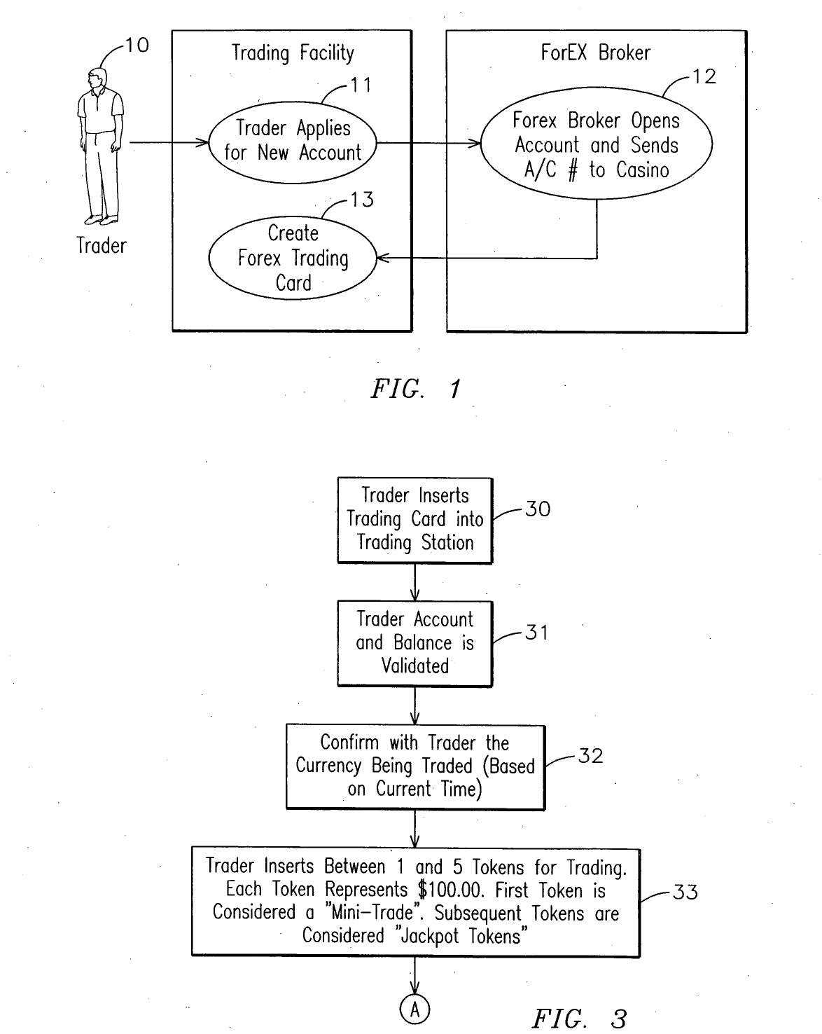

Referring to the drawings, FIG. 1, the first step in the present process of executing a transaction is the opening of a trading account with a Foreign Exchange currency, or Forex, Broker. The trader 10 applies for a new account (11) on-line or through an application from a trading facility. The Broker opens the account (12) and sends the account number to the trading facility which then creates a trading card (13) for the new trader for use in the trading facility. Arrangements have already been made with the Forex broker to handle small currency trades in a simultaneous buy-sell transaction with the sell order being executed only upon a predetermined up or down swing in the currency with the Broker getting a set commission on the small trades. The trading facility provides tokens of a predetermined denomination, such as $100. U.S. for the trader to use in the trading station.

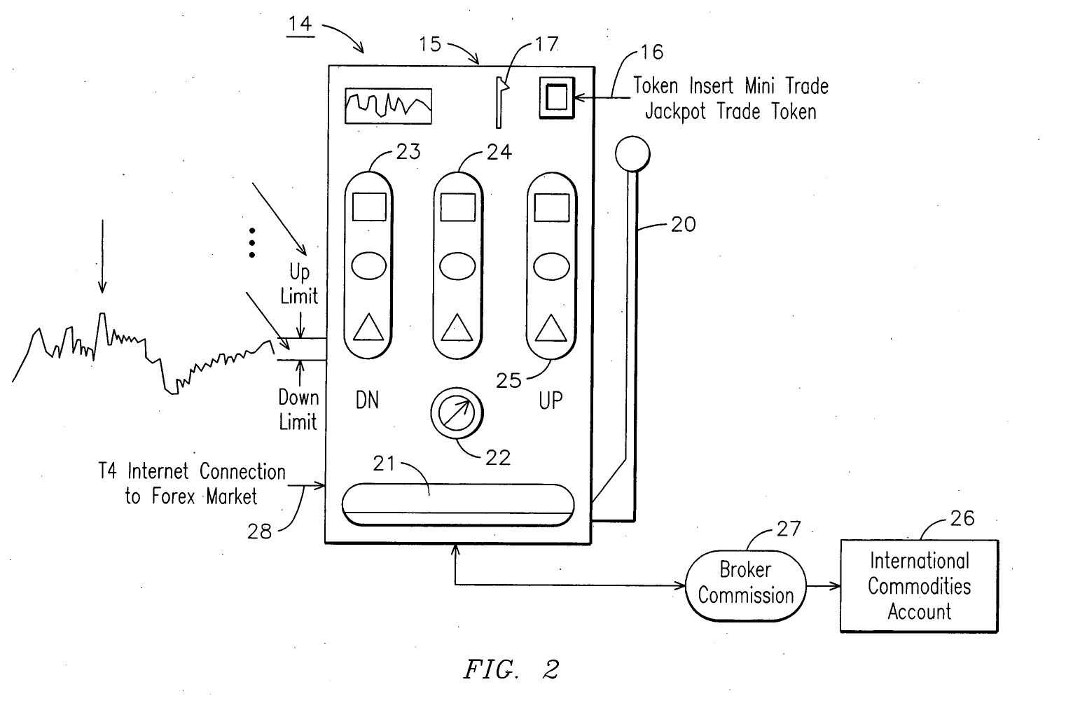

The present process utilizes a trading station which can utilize a standard PC type computer to execute the trades with interfacing software to set the trading or buy sell orders to the broker. A custom Forex trading station 14 is seen in FIG. 2 having a housing 15 and a token inserting slot 16 and a trader's registration card insert 17. A display 18 has a continuous feed of data on the value of currency on the Euro to U.S. Dollar rates fed from an internet connection. The trading station may be set up to look like a slot machine in a casino if desired having a trade initiation lever 20 and a token return 21. The trading station 14 may also have a trade selector 22 which allows the trader to select the rise and fall of the currency values needed to automatically execute the sale of the purchased currency. For display purposes the trading station 14 may also have rotating display wheels 23, 24 and 25. The trading station is connected over the internet to the broker and the broker takes a broker's commission 27. The internet connection 28 can be through a T4 internet connection or the like. The data being fed to, the trading station is received from different parts of the world depending upon which hours the trading station is being operated. In the U.S. trading is done between 9 AM and 5 pm EST while data between 5 pm and 2 am EST can be obtained from an Asian exchange and trading data between 2 am and 9 am EST is obtained from a European exchange. The rotating wheel display 24 might indicate that the trader has made a profit by the buying or currency and automatically selling the currency at the set limit he has chosen. If the right or left wheel stops the trader has lost the value of the token that he has put into the token insert 16. The trading station may also have a jackpot arrangement where the trader can receive multiple tokens upon extreme movement in the market in his selected direction. Coin can be returned in the token return tray 21 to provide additional interest to the trading.

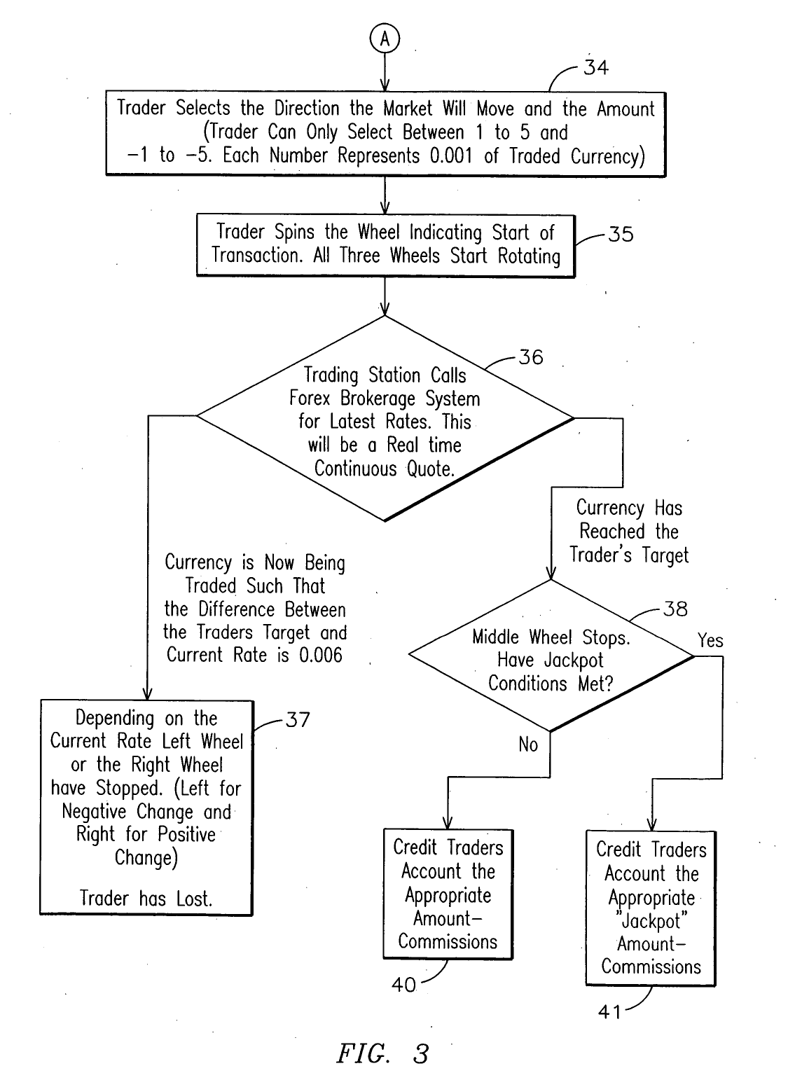

A flow diagram of the present trading process can be seen in FIG. 3. A trader inserts (30) his trading card or account ID in the trading station where the trader account and balance in his account is validated (31). The trader confirms (32) the currency being traded, such as dollars to Euros. The trader then inserts (33) between 1 and 5 tokens for trading, with each token representing $100.00. The first token is considered a mini trade while subsequent tokens are considered jackpot tokens. The trader then selects (34) the direction the market will move and the amount of movement. The will normally be limited to selecting 1 to 5 or −1 to −5, each number representing 0.001 of traded currency. The Trader then spins (35) the wheels, if using a trading station as shown in FIG. 2, to start the transaction. All three wheels will begin rotating. The spinning of the wheels or entry into a computer sends (36) the order on-line to the Forex brokerage firm system for the latest rates and a real time continuous quote. The currency is now being traded such that the difference between the traders target and the current rate is 0.006. Depending on the movement of the currency rate, the left wheel or the right wheel stops when the currency rate reaches the set limit opposite to that chooses by the trader indicating that the trader has lost (37) the value of his tokens. If on the other hand the currency reaches the target level picked by the trader the middle wheel stops (38) indicating the trader has won and determines whether the conditions for a jackpot have been met. If the jackpot conditions have not been met, the traders account is credited (40) the appropriate amount less brokerage commissions. If the jackpot conditions have been met, the trader's account is credited the appropriate jackpot amount less commissions.

The operation starts with the opening of the trading station facility and opening a trading account in New York and wiring dollars to the trading account. The trading facility becomes a partner to trading brokerage and receives a commission for every trade initiated on any of the registered trade stations. The registered trader may then receive a trading credit card. The trader receives a quantity of trade tokens no higher than representing balance his account with each token representing a $100 initial trade. The trader goes to any trade station in the trading facility and inserts his personal registered trading credit card to activate the trading station. All trading stations are connected via the Internet to the Forex trading broker. The trading station selects automatically the trading pair, such as Euro/dollars and depending upon the time selects the trading exchange. The U.S. is selected if between the hours of 9 am and 5 pm EST and Europe is selected if between 2 am and 9 am EST and Asia is selected between 5 pm and 2 am EST. The equipment can be operated from Monday to Saturday, as the Forex trading market is worldwide open for those days.

The trader inserts 1 to 5 tokens of which 1 $100 token represents a mini trade and the second $100. token represents a jackpot trade. If the trader stays with one trading station, the jackpot token stays until the market hits the target or trade goal, which only will happen if the market reacts extreme. The trading station machine may be present. If only one token in inserted, the trade can only be one mini trade.

The trader now selects either an up or down trade, which could be represented in numbers or symbols. In case of symbols, each symbol represents a specific number between plus 1 to 5 or minus −1 to −5. The trader sees on the live display if the market moves up or down. The trade is always in the third decimal of the traded currency.

The trader pulls the trading lever or initiates the trade through a dedicated computer and the trade is immediately initiated. The middle wheel represents the numbers 1-5, minus −1 to −5 or dedicated symbols. If the selector is set at 5, the wheel will rotate. This represents an up trade. The middle wheel will come to a holds if either the market hits the trade goal, the other two wheels left and right will in this case stop with the same number or symbol as the middle wheel. If the trader wins the trade, his account is automatically credited in New York and the machine will disburse token in the same amount. If trader has placed two tokens and the market reacted extreme, the trade goal is reached and the machine will disburse the jackpot in token, which may happen at any time. If the trader decides to down trade and the middle wheel stops again when the goal is reached, indicating the trader has won. Similarly, if the trader decides to up trade, the middle wheel stops when the up goal is reached.

If the trade goes in the other direction than the selected trade it will hit either the down or up limit, which is set at −6 to +6 from the starting decimal of the trade. Now either the right or left wheel will stop first, which means the market hit the limit, the trade is ended, and the trader lost.

If the trader selects +5, the market was at a starting point of −1, and if the Market went down to −7 the left wheel will stop and immediately the other two wheels stop all with different numbers or symbols. The trader chooses a down trade −3, the market goes in the up direction and the right wheel will stop, when the market hits +3. The trader lost, the right wheel, stops as the market hit the limit and the other two wheels follow all with different numbers or symbols. The jackpot is initiated if the market hits the jackpot trade at any time independent from any mini trade.

Any profit is disbursed by symbolic tokens with lights and music sounds to the token tray of the machine. The actual profit is credited to the trading account while losses are debited.

If the market moves up or down, the machine will always adjust automatically to accommodate a delta from −5 to +5 in the third decimal.

The game is, if the middle wheel stops, it is a winner, if the right or left wheel stops, the trader loses. The opportunity for a jackpot always exists where the market make extreme movements in a short period of time on the upswing, if the machine is preset for the upswing.

I claim:

1. A process of executing a transaction for asset purchase and sale comprising the steps of;
opening a trading account with a broker and receiving an account number;
purchasing a token of a predetermined currency denomination;
selecting a trading station having a housing and a display and having an on-line input of asset trading data displayable on said display and having a token input and having an output to a transaction broker for handling trades and means for actuating a trade with said transaction broker;
entering said trader account number into said trading station;
selecting a type of trading transaction;
inputting said purchased token into said token input of said trading statio;
actuating a buy trade of an asset through said transaction broker for the amount of said purchased token; and
actuating a sell trade of said bought asset through said transaction broker responsive to a predetermined targeted change in market prices for the purchased asset;
whereby an asset buy and sell transaction is initiated from a trade station.

2. The process of executing a transaction for asset purchase and sale in accordance with claim 1 including the step of issuing a trading card having a trading account number thereon to a trader.

3. The process of executing a transaction for asset purchase and sale in accordance with claim 2 including the step of selecting criteria for the sale of purchased assets.

4. The process of executing a transaction for asset purchase and sale in accordance with claim 4 in which the bought asset is currency.

5. The process of executing a transaction for asset purchase and sale in accordance with claim 1 in which said step of selecting a trading station includes selecting a trading station having a plurality of rotating wheels each having a plurality of graphic symbols thereon.

6. The process of executing a transaction for asset purchase and sale in accordance with claim 5 in which said step of selecting a trading station includes selecting a trading station having an actuating arm.

7. The process of executing a transaction for asset purchase and sale in accordance with claim 6 in which the step of selecting criteria for the sale of purchased assets includes selecting a direction and degree of change in a currency valve for the execution of the sell order.

8. The process of executing a transaction for asset purchase and sale in accordance with claim 7 in which the step of selecting a trading station includes selecting a trading station having a token output opening for outputting tokens for winning sales of a currency.

9. The process of executing a transaction for asset purchase and sale in accordance with claim 8 including the step of selecting a jackpot criteria for a more extreme change in the market for a currency.

10. The process of executing a transaction for asset purchase and sale in accordance with claim 9 in which a jackpot criteria is selected by the use of a plurality of token.

11. An asset trading process comprising the steps of:
selecting a trading station having a housing and a display and having an on-line input of asset trading data displayable on said display and having a card reader and having an output to a transaction broker for handling trades and means for actuating a trade with said transaction broker;
opening an account for an individual with said transaction broker and issuing a brokerage account number and account card;
validating said brokerage account number in said card reader in said selected trading station;
selecting trading criteria on said selected trading station for trading an asset;
actuating a short term trade of an asset with said trade actuating means; and
receiving feedback on said trade;
whereby trading can take place through a trading station remote from a broker's office.
